(19) United States
(12) Patent Application Publication
(10) Pub. No.: US 2024/0212121 A1
(43) Pub. Date: Jun. 27, 2024

(54) SYSTEM AND METHOD FOR PREDICTIVE MONITORING OF DEVICES

(71) Applicant: ODYSIGHT.AI LTD., Omer (IL)

(72) Inventors: Amir GOVRIN, Ramat Gan (IL); Yekaterina DLUGACH, Mabuim (IL); Arik PRIEL, Givat Shmuel (IL); Yishaia ZABARY, Tel Aviv (IL); Yehu OFER, Mishmeret (IL); Jacob AVINU, Netiv Hashayyara (IL)

(21) Appl. No.: 18/395,676

(22) Filed: Dec. 25, 2023

Related U.S. Application Data
(60) Provisional application No. 63/435,390, filed on Dec. 27, 2022.

(51) Int. Cl. G06T 7/00; G06T 7/20

(52) U.S. Cl. CPC G06T 7/0004; G06T 7/20

(57) ABSTRACT

A system, method and computer program product, the method comprising: receiving an image depicting two or more parts of a monitored device, a first part subject to a first failure mode, and a second part subject to a second failure mode; identifying in the image the first and second parts; detecting whether the first part is assumed to comply with the first failure mode, comprising using a first engine, and whether the second part is assumed to comply with the second failure mode, comprising using a second engine; verifying whether the first part complies with the first failure mode or not, and verify whether the second part complies with the second failure mode or not; and taking an action subject to the first part complying with the first failure mode or the second part complying with the second failure mode, the action aimed at avoiding a malfunction of the device.

### CROSS-REFERENCE TO RELATED APPLICATION

This application claims the benefit of U.S. Provisional Patent Application No. 63/435,390, filed Dec. 27, 2022, entitled “System and Method for Predictive Monitoring of Devices” which is hereby incorporated by reference in its entirety without giving rise to disavowment.

### TECHNICAL FIELD

The present disclosure relates to an automated system and method for predictive maintenance in general, and monitoring the health of devices in an efficient manner, in particular.

### BACKGROUND

Machine maintenance relates to retaining the functionality and safety of machines, including but not limited to mechanical, electrical, optical, hydraulic and other systems or combinations thereof. Proper maintenance is aimed at meeting the functionality and safety goals while minimizing the maintenance cost and labor on the long run, including reducing the downtime of the machine or directing this time to the most convenient time slots.

Currently, machine maintenance mainly includes periodical scheduled servicing, routine checks, and unscheduled emergency repairs. The scheduled service and routine checks are planned according to statistical and/or historic data of the mean time between failures (MTBF), expressed in total time, operation time, distance or other units, or a combination thereof. For example, a car visit to the garage may be set to the earlier of driving 10,000 miles or one year after the current visit. However, such schedule, especially when taking into account safety margins, tends to be more frequent than necessary. This frequency may incur the cost of unnecessary technician visits, and replacement of fully functional parts or supplies which may be subject to failure before the next visit. On the other hand, such scheduled maintenance may miss emergency situations which could have been observed earlier and handled more easily. Other machine maintenance techniques include using sensors for predictive maintenance, as detailed for example in PCT publication WO2022/162663 filed Jan. 27, 2022, titled “Systems and Methods for Monitoring Potential Failure in a Machine or a Component Thereof”, incorporated herein by reference in its entirety and for all purposes.

### BRIEF SUMMARY

One exemplary embodiment of the disclosed subject matter is a system, comprising: one or more processors programmed to: receive an image captured by a camera, the image depicting at least two parts of a monitored device, a first part of the at least two parts subject to at least one first failure mode, and a second part of the at least two parts subject to at least one second failure mode; identify in the image the first part and the second part; detect whether the first part is assumed to comply with the at least one first failure mode, comprising using at least a first engine, and whether the second part is assumed to comply with the at least one second failure mode, comprising using at least a second engine; verify whether the first part complies with the at least one first failure mode or not, and verify whether the second part complies with the at least one second failure mode or not; and take one or more actions subject to the first part complying with the at least one first failure mode or the second part complying with the at least one second failure mode, the at least one action aimed at avoiding a malfunction of the device. Within the system, verifying whether the first part complies with the at least one first failure mode or not, and verifying whether the second part complies with the at least one second failure mode or not optionally comprises: retrieving from a storage device a stored characteristic of stored interrelationship between the first part and the second part; analyzing within the image a current characteristic of current interrelationship between the first part or the second part; determining whether the current characteristic complies with the stored characteristic; subject to the stored interrelationship representing proper multi-part interrelationship, and the current characteristic not complying with the stored characteristic, or to the stored interrelationship representing improper interrelationship between the first part and the second part and the current characteristic complying with the stored characteristic, determining to take the at least one action. Within the system, the at least one first failure mode and the at least one second failure mode are optionally static failure modes. Within the system, a static failure mode of the at least one first part optionally causes the at least one second failure mode. Within the system, the at least one first failure mode and the at least one second failure mode are optionally due to a common cause. Within the system, the at least one first failure mode is optionally a static failure mode and the at least one second failure mode is optionally a dynamic failure mode. Within the system, the processor is optionally adapted to analyze a static failure mode in the at least one first part, and motion of the at least one second part that does not comply with an expected motion. Within the system, the at least one first failure mode and the at least one second failure mode are optionally dynamic failure modes. Within the system, the processor is optionally adapted to analyze motion of the at least one first part that does not comply with an expected motion for the first part, and to analyze motion of the at least one second part that does not comply with an expected motion of the second part. Within the system, the stored interrelationship of the first part and the second part optionally indicate synchronization in time or space between motions of the first part and the second part, and wherein detecting whether the second part is assumed to comply with the at least one second failure mode comprises detecting whether a second motion of the at least one second part is incompatible in time or space with a first motion of the at least one first part. Within the system, the processor is optionally further adapted to train an engine by providing as input a collection of sets of images captured by the image capture device depicting interrelationship between the at least one first part and the at least one second part, each set of images labeled as proper or improper, and wherein the engine is adapted to receive a set of images and predict whether the first part and the second part move in expected trajectories and in synchronization. Within the system, the stored interrelationship have optionally been obtained by an engine receiving as input for training a collection of sets of images generated by a simulator depicting interrelationship between the first part and the second part, each set of images labeled as proper and improper. Within the system, the stored interrelationship have optionally been obtained by analytic input depicting proper interrelationship between the first part and the second part. The system can further comprise: a camera configured to capture the image of the monitored device. Within the system, the detecting whether the first part is assumed to comply with the at least one first failure mode is optionally performed automatically. Within the system, the at least one action optionally comprises alerting a user. Within the system, the at least one action optionally comprises scheduling a maintenance operation. Within the system, the at least one action optionally comprises analyzing a trend of the failure mode. Within the system, the at least one action optionally comprises suggesting a change to the operation mode of the monitored device or a part thereof. Within the system, the at least one action optionally comprises one or more items selected from the group consisting of: changing a capture rate for the camera; setting an analysis rate for at least a portion of further images captured by the camera; sending a message to a person in charge; storing an alert in a storage device; and updating a database. Within the system, the image is optionally divided into tiles, and wherein at least one tile is analyzed at a different frequency from at least one other tile. Within the system, the image is optionally divided into tiles, and wherein at least one tile is analyzed by a different engine from at least one other tile.

Another exemplary embodiment of the disclosed subject matter is a method for monitoring a device, comprising: receiving an image captured by a camera, the image depicting at least two parts of a monitored device, a first part of the at least two parts subject to at least one first failure mode, and a second part of the at least two parts subject to at least one second failure mode; identifying in the image the first part and the second part; detecting whether the first part is assumed to comply with the at least one first failure mode, comprising using at least a first engine, and whether the second part is assumed to comply with the at least one second failure mode, comprising using at least a second engine; verifying whether the first part complies with the at least one first failure mode or not, and verifying whether the second part complies with the at least one second failure mode or not; and taking at least one action subject to the first part complying with the at least one first failure mode or the second part complying with the at least one second failure mode, the at least one action aimed at avoiding a malfunction of the device. Within the method, verifying whether the first part complies with the at least one first failure mode or not, and verifying whether the second part complies with the at least one second failure mode or not optionally comprises: retrieving from a storage device a stored characteristic of stored interrelationship between the first part and the second part; analyzing within the image a current characteristic of current interrelationship between the first part or the second part; determining whether the current characteristic complies with the stored characteristic; subject to the stored interrelationship representing proper multi-part interrelationship, and the current characteristic not complying with the stored characteristic, or to the stored interrelationship representing improper interrelationship between the first part and the second part and the current characteristic complying with the stored characteristic, determining to take the at least one action.

Yet another exemplary embodiment of the disclosed subject matter is a computer program product comprising a non-transitory computer readable medium retaining program instructions, which instructions when read by a processor, cause the processor to perform: receiving an image captured by a camera, the image depicting at least two parts of a monitored device, a first part of the at least two parts subject to at least one first failure mode, and a second part of the at least two parts subject to at least one second failure mode; identifying in the image the first part and the second part; detecting whether the first part is assumed to comply with the at least one first failure mode, comprising using at least a first engine, and whether the second part is assumed to comply with the at least one second failure mode, comprising using at least a second engine; verifying whether the first part complies with the at least one first failure mode or not, and verifying whether the second part complies with the at least one second failure mode or not; and taking at least one action subject to the first part complying with the at least one first failure mode or the second part complying with the at least one second failure mode, the at least one action aimed at avoiding a malfunction of the device.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is an exemplary illustration of images depicting detected parts in a device and the associated failure modes, in accordance with some exemplary embodiments of the disclosure;

FIG. 2A is a flowchart of steps in a method for detecting failure modes and taking responsive actions, in accordance with some exemplary embodiments of the disclosure;

FIG. 2B is a flowchart of steps in a method for scene analysis and failure mode retrieval, in accordance with some exemplary embodiments of the disclosure;

FIG. 2C shows a flowchart of steps in a method for detecting failure modes that involve interrelationships between parts, in accordance with some exemplary embodiments of the disclosure.

FIG. 3 is a flowchart of steps which may be performed during preprocessing, in accordance with some exemplary embodiments of the disclosure;

FIG. 4 shows usage of some options for detecting parts within an image, in accordance with some exemplary embodiments of the disclosure;

FIG. 5 shows usage of some options for detecting parts of the monitored device, in accordance with some exemplary embodiments of the disclosure;

FIGS. 6A-6G show an example of a single frame capturing a complex comprising multiple parts as well as one or more other parts or complexes, and their detection and identification, in accordance with some exemplary embodiments of the disclosure;

FIGS. 7A-7F show the motion trajectories of reference points P1-P5 during proper operation of the complex, upon which dynamic failure modes may be identified, in accordance with some exemplary embodiments of the disclosure;

FIG. 8 is a flowchart of steps in a method for suppressing situations, in accordance with some exemplary embodiments of the disclosure; and

FIG. 9 is a block diagram of a system for detecting failure modes and taking a responsive action, in accordance with some exemplary embodiments of the disclosure.

### DETAILED DESCRIPTION

In the disclosure, the term “failure” or “failure point” is to be widely construed to cover any situation or problem in one or more parts of a machine, which causes harm such as breakdown, dangers a user or another person or equipment, or requires immediate handling or replacement of a part of the machine. Some examples include disconnection of a pipe, mechanical break, significant rust, or the like.

In the disclosure, the term “fault” or “fault point” is to be widely construed to cover any undesired effect or process in a part of a machine, which may or may not lead to a failure, but requires follow-up, to analyze whether it needs to be repaired or replaced.

In the disclosure, the term “failure mode” is to be widely construed to cover any effect that can occur to a part of a monitored device and may indicate a problem, such as rust, break, crack, rotation, disabled movement, wrong movement synchronization between components, wrong trajectory, or the like. It is appreciated that a part may be subject to a plurality of failure modes, related to different characteristics or functionalities thereof. For example, a screw may be rusted, as well as unscrewed.

The term “dynamic failure mode” is to be widely construed to cover any failure mode associated with the movement or motion of a part, such as but not limited to movement in a trajectory or assuming positions other than expected, wrong timing of movement, mis-synchronization between parts that are supposed to move in synchronization, or the like.

The term “static failure mode” is to be widely construed to cover any failure mode associated with the state of a part, such as but not limited to break, tear, rust, position change, color change, leak, or the like.

The term “complex” is to be widely construed to cover any component or sub-system of the monitored device, which comprises two or more parts, wherein each part of the complex is connected physically or functionally to at least one other part of the complex, and wherein some of the parts may move relatively to other parts.

The term “multi-part failure mode” is to be widely construed to cover any situation in which two or more parts or complexes are captured in a single frame, wherein at least one of the parts or complexes is in a failure mode, whether static or dynamic. In some situations one of the failure modes may cause the other, in further situations another reason may cause both failure modes, and in further situations the failure modes may be unrelated to each other.

The term “interrelationship” is to be widely construed to cover any aspect of commonality between two or more parts captured in a same image, such as being part of a same complex, one of the parts influencing the functionality of another, being subject to failure modes due to a common cause, or the like. Some stored interrelationship may refer to proper behavior of the parts, while others may refer to improper such behavior, which may indicate a failure mode of either part.

In the disclosure, the term “trend” or “trend of failure mode” is to be widely construed to cover any behavior over time of a failure mode, when or under what circumstances the fault will turn into failure. The trend is optionally associated with additional circumstances such as environmental conditions, mode of operation of the device, usage characteristics of the device, characteristics of a user of a device such as a driver of a vehicle, or the like.

In the disclosure, the term “camera” is to be widely construed to cover any device comprising an image sensor capable of detecting and converting optical signals in the visible and invisible wavelengths, such as near-infrared, infrared, visible and ultraviolet spectrums into electrical signals. The term includes but is not limited to a camera, a video camera, a thermal camera, a depth camera, or others. It is appreciated that three-dimensional data of one or more captured parts may be obtained from a plurality of two dimensional images taken at different angles relative to the captured parts, from depth images, or the like.

In the disclosure, the term “engine” is to be widely construed to cover any software, firmware or hardware mechanism or any combination thereof, adapted to receive input and output a decision based on the input. An engine may be a trained engine which may be trained using supervised or unsupervised training, a machine learning engine, Intelligence (AI) engine, a rule engine, or any other type. The engine may be pre-trained, whether using supervised or unsupervised training. One or more engines may be classifiers adapted to classify the input into one or more of a plurality of classes. An engine may be re-trained over time, to incorporate new information and analyses.

In the disclosure, the term “environmental parameters” is to be widely construed to cover any condition or characteristic of an environment of the monitored device, such as a parameter obtained by a sensor such as temperature, humidity, pressure, vibration, motion, or the like. In some embodiments, the term may also cover operational parameters of the device such as time of operation, status of operation, historical data on operation or the like. In some embodiments the term may also cover behavioral parameters of a user of the device, such as driving or flying habits, carefulness, or the like.

One technical problem dealt with by the disclosed subject matter relates to the need for proper maintenance of devices, machines, or the like. Current maintenance procedures include periodic service, routine checks, and unscheduled emergency repairs. These routines may result in unnecessary visits and maintenance operations only because a certain time/activity have passed on one hand, and late discovery of problematic situations on the other hand, which may lead to more severe problems, failures, or the like.

Some maintenance solutions make use of various sensors installed within or in the vicinity of the monitored device, measuring temperature, humidity, pressure, vibration, or the like. However, such measurements may not always be sufficient for discovering problems. Moreover, they may only exhibit change once a failure has already occurred, thus they may only indicate problems when it is too late, while early indications of the problem have been ignored or misinterpreted. Moreover, a plurality of sensors incurs extra cost and processing requirements. For example, a plurality of cameras is not only costly, but also requires significant processing resources for combining the information provided by the plurality of images taken by different cameras.

Some failure mode monitoring solutions are provided in PCT publication WO2022/162663 filed Jan. 27, 2022 and titled “Systems and Methods for Monitoring Potential Failure in a Machine or a Component Thereof”, incorporated herein by reference in its entirety and for all purposes.

One technical solution of some embodiments of the disclosure comprises a method and system for preventive maintenance of machines, devices, or the like. In some embodiments, the solution includes a camera positioned in, on, or in the vicinity of a device to be monitored, and which may take images of parts of the device at predetermined time intervals or video frames.

In some embodiments, the camera may be of small dimensions, such that it can be installed in narrow places, or otherwise hard or impossible to access locations. For example, a camera may be round, square, or of any other shape. The camera dimensions can be as small as 0.5×0.5 mm, 1 mm×1 mm, 25×30 mm or more. The camera field of view of the camera can be between about 30 and about 140 degrees or even more. The frame rate can be 2-120, 30-120 frames per second or more. The camera resolution may be 200×200p, 400×400p, 800×800p, 1 Mp, 5 Mp or more. The camera weight can be about 0.003 grams, 0.4 grams or more.

According to some embodiments, the images taken by a single camera may capture one, two or more parts or complexes of the device which are subject to failures and require monitoring. The usage of a single camera to monitor two or more parts or complexes may enable the usage of fewer cameras and the analysis of fewer images. Capturing multiple parts or complexes in one image, wherein one complex or sub-system may comprise multiple parts, may thus reduce the camera purchase and deployment cost, as well as the required processing, thereby enhancing the efficiency and reducing the costs associated with the device maintenance.

It is appreciated that the images may be taken and analyzed during operation of the monitored device, such that the device may be monitored without stopping it, as is sometimes required for technician visits. Furthermore, imaging the device during operation enables ongoing or frequent monitoring. Moreover, some failure modes, for example some dynamic failure modes may be discovered only if the device is imaged while it is being operated.

On a preliminary step, scene analysis may be performed for detecting and identifying one or more parts within the scene captured by the camera, and retrieving relevant failure modes. The preliminary scene analysis may be performed once the camera is installed, or at predetermined time intervals. In moving or vibrating environments, the preprocessing and further processing may be performed more often due to relative movement between the camera and the monitored parts.

In some embodiments, the further processing includes only identifying one or more parts in the image without repeatedly retrieving the failure modes of the same parts.

In some embodiments, detecting and identifying parts is performed automatically using one or more engines. In addition, in some embodiments, retrieval of relevant failure modes is also performed automatically using one or more database queries, engines, or the like.

After the preliminary scene analysis, captured images may be examined for detecting whether one or more parts are in a failure mode.

Thus, an image taken by the camera may be examined to identify whether any changes occurred in the image relative to an image previously captured by the camera, for example within a predetermined time frame. The examination may be performed, for example, by a simple change detection algorithm to analyze pixels in the image. If no change is identified, execution may proceed to capturing a next image.

In some embodiments, if changes are detected the images may be provided to a filtering engine which may be a part of a suppression module to remove some artifacts such as light change, occlusion, or the like. Further, changes that are known to be non-problematic or caused by effects which are irrelevant for maintenance, e.g., blinding or fly on image may also be ignored.

In some embodiments, optionally following the filtering, the images may be further examined by the suppression module to identify whether any of the detected changes comply with a possible failure mode. The changes are detected in the entire image or only at a portion of the image depicting a part with which the failure mode is associated. Optionally, additional data may be provided to the suppression module, which may verify whether the part is in one of the retrieved failure modes, or whether the change is not included in a list of changes to be ignored.

In some embodiments, failure modes may be identified without detecting changes in one or more images. For example, one or more AI engines, which may implement machine learning algorithms or other techniques may be used for identifying failure modes. The engines may be trained upon a plurality of images or image sets labeled as proper or as demonstrating a failure mode of one type or another. Once trained, the engines may classify further images or image sets as proper or containing any of the failure modes it has been trained upon.

In some embodiments, multi-part failure mode may also be examined, by retrieving characteristics of stored interrelationship between two complexes or between a complex and a part, and comparing them to current interrelationship detected in an image. If the stored interrelationship indicates a failure mode and the current characteristics complies with the stored one, or the stored interrelationship indicates a proper behavior and the current characteristics does not comply with the stored one, the change may indicate a multi-part failure mode.

If the change is not to be ignored, then in accordance with some exemplary embodiments of the disclosure, at least some of the images may undergo preprocessing, to make further processing more efficient and reliable.

Following the preprocessing, in some embodiments, the images may be processed to detect the parts to be monitored. In some embodiments, locating and detecting parts is performed automatically using one or more engines.

Processing may further include identifying the parts in order to specifically analyze faults in the identified part, and determining whether the state of one or more identified parts complies with any of a number of retrieved failure modes. In some embodiments, retrieving possible failure modes is performed using one or more engines, such as a classifier, which may classify the part state into one of the relevant failure modes.

It is appreciated that some processing, such as multi-part failure mode analysis may be performed at the processing stage instead of or in addition to being performed during filtering. In some embodiments, the image may be divided into tiles, wherein one or more tiles may be subject to less frequent analysis than one or more other tiles, due to the failure modes relevant to parts appearing in the tiles. For example, screws may be monitored for rust less often than moving part is monitored for wrong trajectory, and thus a tile containing a part subject to rust need not be analyzed as often as tiles containing parts subject to movement. It is also appreciated that due to the different failure modes, one or more tiles may be subject to analysis by a different engine than at least one other tile.

Upon verification of failure mode associated with the part, a relevant fault may be identified. Optionally, a trend is also assessed to detect the rate of change of the fault and optionally when and/or under what circumstances the fault will lead to a failure.

In some embodiments, upon identification of a fault or a trend one or more predetermined actions may be taken, such as sending a message to a person in charge, updating a database, scheduling a technician visit, or the like. In severe cases, the machine may be automatically shut down, or another action may be taken to avoid a dangerous situation. In some embodiments, an action may comprise changing the frame rate of the camera, or changing the rate at which images captured by the camera, or portions of such images are examined for fault. It is appreciated that any of the fame rate and the examination rate, which may differ for different areas of the image, may be increased or decreased relative to a current rate. For example, it may be determined that there is no need to check a particular part every day, and it should only be checked within a week. Alternatively, it may be determined that a specific part requires more frequent examination. In further examples, it may be suggested to change a mode of operation of a system or a complex, for example reduce a number of cycles per minute of a rotating part, in order to slow down the development of a failure mode.

In some embodiments, if there is no verification, e.g., no failure mode associated with the part is identified, the captured image or part thereof, associated with a label of “no fault” may be added to a training set of the respective engine. In some embodiments, in addition to the image and label, the training set may also include additional data, such as operational or environmental parameters. Then, once the engine is re-trained, it may better distinguish images similar to the current one as being not faulty, with or without the operational or environmental parameters. This may enable to allow some statuses when the device is under certain conditions and reject them in other situations.

It is appreciated that in some embodiments the processing may be distributed over a plurality of processing devices, one or more of which may be located within the camera, within a same housing as the camera, in the vicinity of the device, or remotely, for example as a cloud computer. The distribution may be selected to optimize the physical size of the module, computing capabilities and energy consumption considerations. For example, processing within the camera may increase the size of the camera module installed in the device.

It is also appreciated that in some embodiments one or more of the preprocessing, part identification, fault identification and verification may be performed over a batch of images to further reduce processing requirements. For example, if the device and the camera are stably located, or their relative movement can be analyzed, the parts do not have to be identified anew in each image, rather the part locations may be determined once and used for a plurality of images.

In some embodiments, where the camera is stationary and images at least a portion of a moving object, such as a cable, the analysis may take into account that sequential images represent different parts of the object.

It is appreciated that in some embodiments the fault identification may replace a technician visit or assist a technician, and may be performed before or after the technician visit.

One optional technical effect of the disclosure provides for smart predictive maintenance of a monitored device or machine, by identifying faults in images of parts of the machine before the faults develop into failures. Such predictive maintenance may increase the time between technician inspections and thus reduce or eliminate the cost and burden of scheduled service visits, unnecessary part replacement, or the like on one hand. Moreover, using some embodiments of the disclosure may potentially prevent unnecessary replacement of parts if it is found that a fault will not turn into a failure if recommended usage or behavior is applied, or if it is determined that the duration for a fault to develop into a failure is longer than the life expectancy of the system. On the other hand, predictive maintenance may enable early identification of hazardous situations or even dormant failures. Early identification may provide for early and relatively cheap correction of the situation, and avoidance of severe damage.

Some embodiments of the disclosure may be used for predictive maintenance of any device of any size having parts for which a fault or failure may be visible, such as engines, wind turbines, aircrafts, boats, trains or other vehicles, elevators, nuclear reactors and cooling chambers thereof, small-size machines, or the like.

Some embodiments of the disclosure may be used for predictive maintenance when the monitored device is in idle static state, or when the device is operative, whether the device or parts of complexes thereof is stationary, moving and/or vibrating. Performing at least some of the analysis when the device is in operation may reduce the device downtime, as the device need not be stopped for health analysis. Eliminating downtime while monitoring the device also provides for more often analysis and hence early identification of failure modes, as detailed above.

Another optional technical effect of some embodiments of the disclosure provides for the camera being able to capture parts or effects which are impossible or hard for a human to see. For example, a camera may be positioned at a location which is inaccessible or hard to reach for a human. In another example, the camera may use wavelengths that are invisible to the human eye but demonstrate a particular problem.

Yet another optional technical effect of some embodiments of the disclosure provides for efficient monitoring of parts of a device, by using a single camera for capturing two or more parts or complexes that may potentially fail, thereby reducing the camera purchase, deployment and operation costs. Moreover, each part may be subject to one or more failure modes which may be different from the failure modes of another part. For example, a screw may be subject to corrosion while a connecter may disconnect. Analyzing one image for different failure modes of different parts may enable more efficient processing, since fewer images may need to be processed, and no registration between separate images is required. The image or different portions of the image may be processed simultaneously by a plurality of engines optionally executed by a plurality of computing platforms. It is appreciated that different parts captured by the same camera may be analyzed at different frequencies. Optionally, different parts can be analyzed by lighting with different wavelengths. Optionally, the different frequencies and/or wavelengths depend on the different failure modes for each part, that is, each part is analyzed based on a frequency and/or lighting wavelength determined by its associated failure mode and previously identified faults.

Optionally, the different examination frequencies may depend on the different failure modes for each part, that is, each part is analyzed based on a frequency determined by its associated failure modes and previously identified faults.

Yet another optional technical effect of some embodiments of the disclosure provides for monitoring a state of the device, to indicate that device is operating properly, without particularly searching for a failure mode. For example, if a certain notification is received such as “wheels not opening” in an aircraft, the wheels opening mechanism may work fine, but the sensor that reports the problem may be malfunctioning. In these embodiments, the described method may be applied to capture the wheels and detect that they are opening, while replacing the failure mode with a safe mode. Another example relates to identification of fluid level in a container, wherein the fluid level is wrongly reported as too low or too high, or the like.

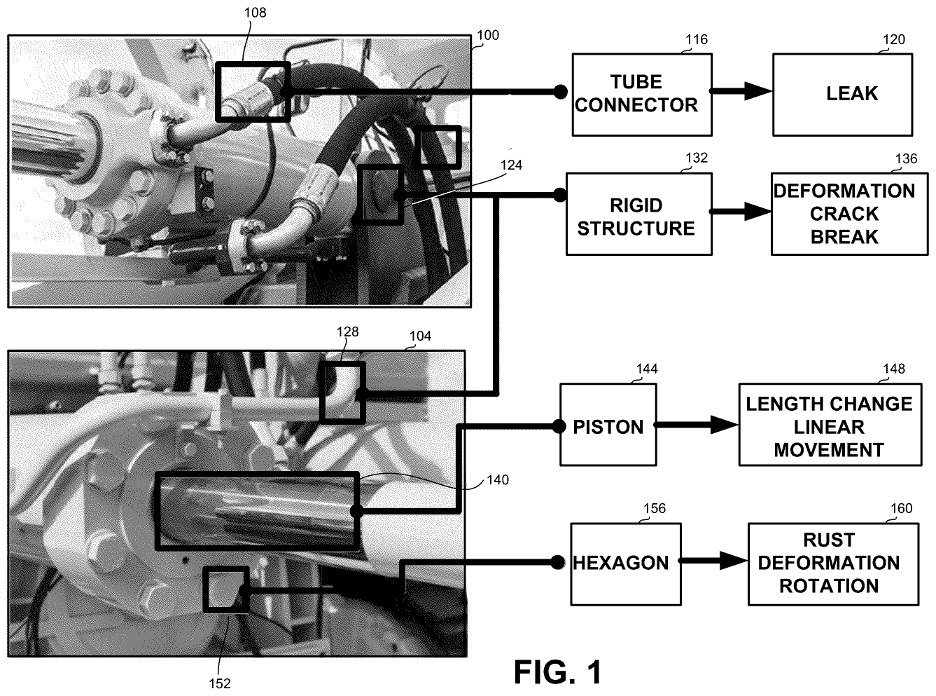

Referring now to FIG. 1, showing an exemplary illustration of detected parts and failure modes in a device, in accordance with some exemplary embodiments of the disclosure.

FIG. 1 shows images 100 and 104 of a device, the images captured by a camera and depicting different portions of the device.

Analysis of image 100 detects part 108, and identifies it as tube connector 116. Retrieval of the possible failure modes of a tube connector provides a failure mode of leak 120. It may then be determined if image 100 shows a leak and if specific tube connector 108 is indeed in a failure mode or is in a proper condition.

The analysis of image 100 and image 104 may also detect parts 124 and 128 and identify them as rigid structures 132. For rigid structures 132 the possible failure modes of deformation, crack or break 136 may be retrieved, and images 100 and 124 may be checked for including any of these failure modes. In some embodiments, the processing of each part, including identical parts, may be done separately, as each part may be in proper state or present a different failure mode. For example, one screw may suffer from rust, while another may get unscrewed. It is appreciated that the analysis may be performed separately for each of images 100 and 104. Also, the existence of a failure mode may be determined per image or per image part.

Further analysis of image 104 may detect part 140 which is identified as a piston 144 which may be subject to length change or linear movement 148, and part 152 identified as a hexagon which indicates a bolt or nut which may be subject to corrosion, deformation, and rotation.

Thus, each of images 100 and 104 may depict one or multiple parts, for example two, three, four, five, six or any other number of parts, which may be of different types and subject to different failure modes, thereby enabling efficient usage of monitoring cameras for detecting a plurality of failure modes, and in particular capturing two parts in an image taken by a single camera. Optionally, some of the failure modes are overlapping for same or different type of parts in one image. It is appreciated that in some embodiments, for some images, only failure modes of a single part of the device is detected using the above analysis.

It is appreciated that the part types and failure modes detailed above are exemplary only, and any other part which can fail in a visually observable manner may also be handled. Some additional examples include the detection of leaking pipes, or verification of cable integrity, fastener tightening, as detailed for example in WO2022/162663 to Govrin et al. incorporated herein by reference in its entirety and for all purposes.

It is appreciated that the camera may be static relative to the monitored device. In some embodiments, for example, the camera may be external to the device. In other embodiments, for example when the monitored device is a vehicle, the camera may be statically mounted on the monitored device and may thus move with it, but may monitor a moving part or complex thereof, such as a landing gear of an aircraft and is therefore static with respect to the monitored device, parts or complexes.

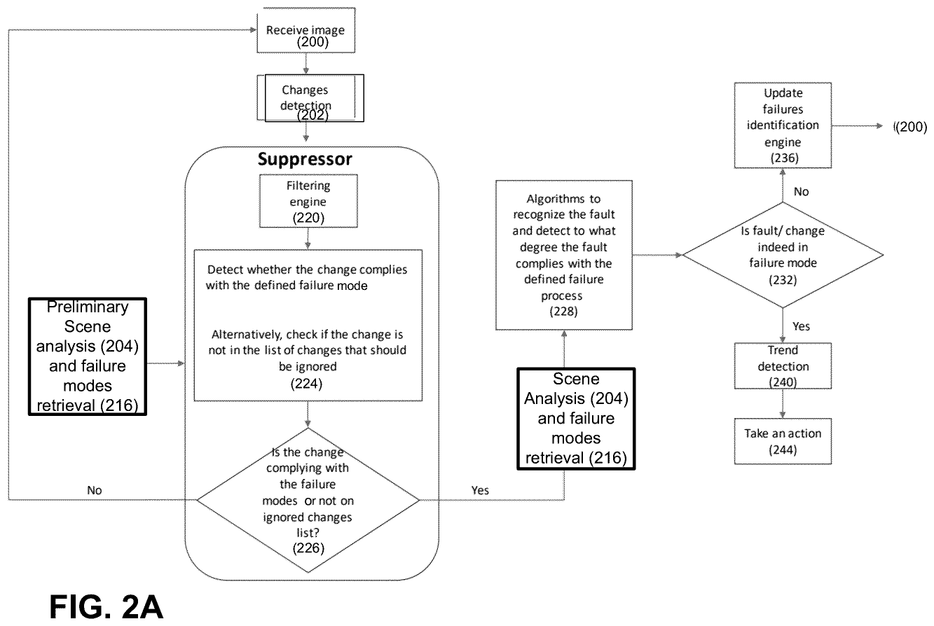

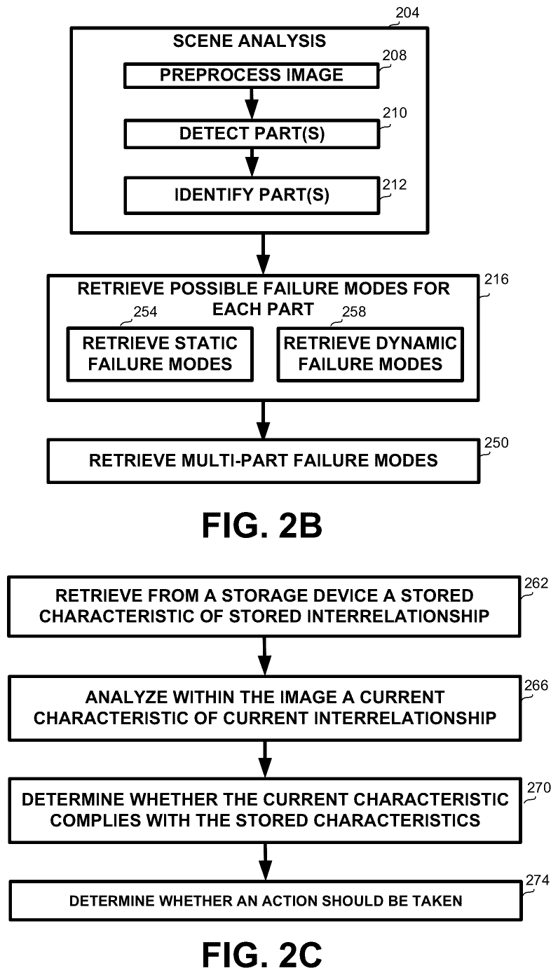

Referring now to FIG. 2A, showing a flowchart of steps in a method for detecting failure modes and taking a responsive action, in accordance with some exemplary embodiments of the disclosure.

As detailed below, some steps of the method may be performed using engines. Optionally, multiple engines may be used in parallel and/or in sequence. It is appreciated that the engines may be of any one or more appropriate types, such as but not limited to any machine learning models or neural networks, convolutional neural networks, deep neural networks, or the like. Some engines may implement a classifier adapted to receive input such as an image, and output a class the input is to be associated with out of a plurality of classes. Alternatively, the classifier may output a confidence level for the input to be associated with any of the classes. Optionally, the output is an enriched representation of the input (e.g., a segmentation mask) or a latent descriptor of the input (i.e., image/objects embeddings or extracted features).

In some embodiments, a plurality of engines employing different techniques or trained upon different training sets may be employed for a same purpose, and the output may be determined upon a combination thereof, such as majority voting, average or weighted average if appropriate, or the like. In some embodiments, the engines are trained using supervised or unsupervised learning.

The process may include step 200 of receiving an image from the camera, from a storage device, over a communication network, or the like. The images may be part of a sequence of still images, video frames, or the like.

It is appreciated that the capture rate of the camera may change and that the following steps may be performed at any required frequency, which may also change over time. For example, for a stationary device captured by a static camera, the images may be processed at predetermined time intervals, such as every hour, every day, every month, after every activation, or the like. In other situations, for example whether the device or the camera are moving, the method may be performed for every image.

The process may include step 202 of detecting whether the image comprises changes relative to a previously captured image. The changes may be performed by simple pixel comparison, or a similar technique. If no change is detected, execution may return to step 200 for receiving another image. In some examples, a change may be the appearance of red pixels indicating rust, a change in an area having a uniform color indicting a crack, or the like.

It is appreciated that step 202 may be applied towards detecting a plurality of failure modes in a plurality of parts captured in an image. For example, a first failure mode may be detected using a first engine, such as a motion detection engine, in a first part, and a second failure mode may be detected using a second engine (which may or may not be the same as the first engine), in a second part. The first engine and the second engine may be image processing engines.

If changes are detected, then the image may be provided to an optional suppressor module, for determining whether the change is indicative of a fault or failure, as detailed below.

A preliminary scene analysis step 204 may take place for detecting one, two, three or more parts within a received image captured by the camera. In some embodiments, a first captured part may be subject to a first failure mode and a second part may be subject to a second failure mode. Scene analysis step 204 may be performed once, for example when the camera is deployed, every predetermined nominal time or operation time, only when motion or pre-defined change is sensed, or the like, and applied to further captured images, thereby saving processing time and resources. In some embodiments, scene analysis 204 may be performed more often for moving or vibrating devices than for stationary devices.

Referring now to FIG. 2B, showing a flowchart of steps in a method for implementing scene analysis 204 and failure mode retrieval 216, in accordance with some exemplary embodiments of the disclosure. Scene analysis 204 may be performed for one or more reference images taken once the camera is deployed and the environment is stable.

Scene analysis 204 may comprise image preprocessing step 208 for enhancing the image in preparation for further processing.

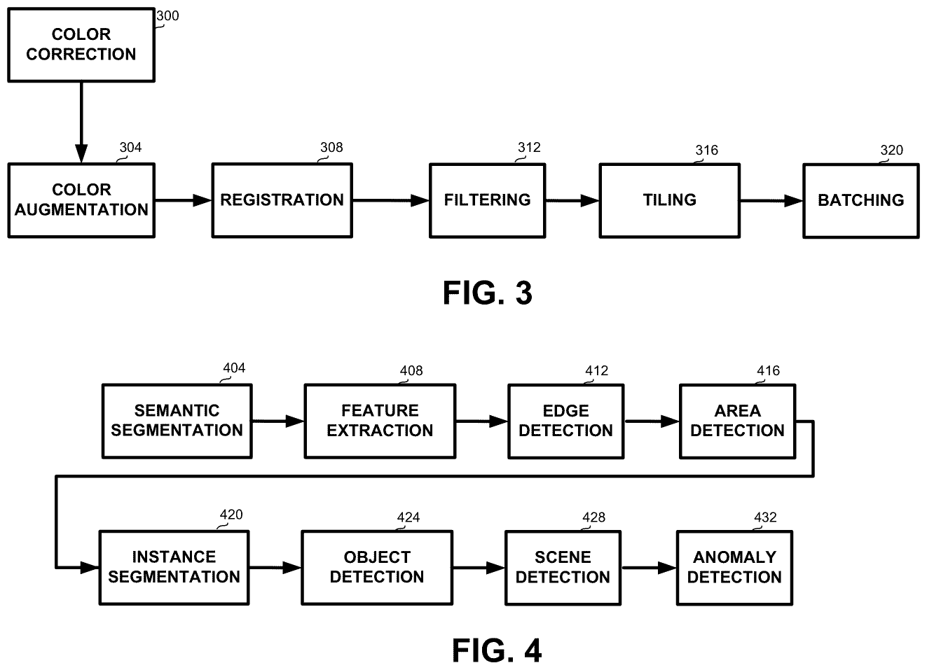

Referring now also to FIG. 3, showing a flowchart of optional steps which may be performed during preprocessing 208, in accordance with some exemplary embodiments of the disclosure. In some embodiments, one or more of the steps may be performed, and optionally preprocessing may include all of the steps shown. In some embodiments, the preprocessing steps are determined according to location of the camera and any operational parameters of the machine or its environment. For example, some of the steps may be performed only when certain lighting conditions occur or when certain faults are detected which require analysis at greater detail.

Preprocessing may include color correction step 300, for enhancing the colors of the image, increasing contrast, enhancing certain wavelengths to make certain effects more prominent, or the like.

Preprocessing may include color augmentation step 304 for generating new transformed versions of the image to increase the data diversity and optionally in order to improve the performance of detection, segmentation and classification models, for determining parameters such as brightness or saturation, or performing contrast hue adjustment.

Preprocessing may include registration step 308 for determining the transformation between two images, expressed for example as a translation and/or rotation and/or scaling parameters or matrix. Obtaining the transformation parameters provides for detecting objects in one image based on the objects' coordinates in another image by applying the transformation to the other image. Registration may be particularly useful for images captured by a moving and/or vibrating camera or device.

Preprocessing may include filtering step 312 for filtering one or more images. Images may be filtered based, for example on being substantially identical to previously captured images, taken at a short time difference (e.g., below a threshold time difference) before or after another image, blurring indicating motion, or the like.

Preprocessing may include tiling step 316 for dividing the images into a plurality of areas, or extracting from the image one, two or more areas of interest. The tiles may be polygons identical in dimensions and shaped, of diverse shape based upon recognized elements, or the like. The tiles may or may not cover the whole area of the images.

Preprocessing may include batching step 320 for enhancing the data processing pipe, for example avoiding bottlenecks resulting from internal memory and data transmission rates. Batching may also include filtering similar images, or in some embodiments using similar images to enhance or enrich the captured scene representation, e.g., create a 3D representation of the captured scene (using a moving sensor for example).

Referring now back to FIG. 2B, scene analysis 204 may comprise step 210 for detecting at least a first part and a second part of the monitored device.

Referring now also to FIG. 4, showing optional steps for implementing part detection step 210, in accordance with some exemplary embodiments of the disclosure.

It is appreciated that the parts may be identified as two dimensional or three dimensional objects within one or more 2D or 3D images. For example, a three dimensional part may be identified using output from a depth camera, or form a plurality of two dimensional images in which at least one part is at a different position relative to the camera.

In some embodiments, part detection step 210 may comprise semantic segmentation step 404, also referred to as scene segmentation step, for segmenting the image for recognizing one, two or more parts, based for example on color, shape, or other characteristics. Semantic segmentation step 404 enables to differentiate between different parts or objects in the image. It can be done at a pixel level for example by labeling any pixel belonging to a certain part. Semantic segmentation can also be based on unsupervised characteristics (such as super pixels techniques where similar adjacent pixels are grouped together). Semantic segmentation may also be based on comparison to a baseline scene for segmentation of anomalies in the current scene compared to a baseline or to previous images.

Alternatively or additionally, part detection step 210 may comprise feature extraction step 408, for extracting features from various portions of the image, such as colors, lines, curves, planes, shapes, or the like. In some embodiments, feature extraction step 408 may be divided into a supervised or engineered features extraction step and unsupervised feature extraction (i.e., latent embeddings features) step.

Alternatively or additionally, part detection step 210 may comprise edge detection step 412 for detecting edges within the image, which may indicate the boundaries of depicted objects, and enables to distinguish between adjacent objects, or between an object and a background.

On step 416 one or more areas of the image may be detected, based on one or more of the above steps, wherein each such area may depict a distinct part of the monitored device.

Alternatively or additionally, part detection step 210 may comprise instance segmentation step 420 for calculating a segmentation pixel-wise mask for multiple instances of an object within a single frame. Unlike semantic segmentation, instance segmentation is aimed at distinguishing similar items of a same class, e.g., two screws, two pipes, or the like.

Alternatively or additionally, part detection step 210 may comprise object detection step 424 which is a machine learning task of recognizing which object(s) are within the frame. Object detection step 424 does not necessarily provide the location (via a pixel-wise mask) of the objects, but rather an indication of whether they exist or not within the frame.

Alternatively or additionally, part detection step 210 may comprise scene detection step 428, which provides information in terms of the entire scene. For example, scene detection step 428 may identify a complex or sub-system comprised of a plurality of parts.

Alternatively or additionally, part detection step 210 may comprise anomaly detection step 432, in which anomalous properties are outlined. For example, an anomaly detection algorithm can be trained on proper operation of a certain machine and upon breakage/malfunction/etc. If the machine operandi changes (e.g., a piston moves up/down instead of left/right) and it may be marked by the algorithm as non-regular, or anomalous.

It is appreciated that one or more of the steps above may be omitted in some embodiments. It is also appreciated that the steps can be performed in any required order, and that the order shown is in no way obliging or essential.

Referring now back to FIG. 2B, scene analysis step 204 may comprise part identification step 212 in which after detecting the one or more parts on step 210, at least one of the parts of the monitored device may be identified as specific parts within the detected areas.

It is appreciated that in some cases only a portion of a part may be depicted in a detected area, for example only a portion of a tube. However, in some situations the depicted portion may suffice for identifying the part and for detecting failure modes the part is suffering from. In some embodiments, where the camera is stationary and images a portion of a moving object, such as a portion of a cable, the analysis may take into account that sequential images represent different parts of the cable. The analysis may relate to each portion separately, e.g., cracks at a certain point which are allowed to a certain degree, or as a whole, i.e., the entire cable is allowed only a certain percentage of rust covering it. Further details related to detecting failure modes in cables or the like can be found in PCT application no. PCT/IL2023/050793 filed Jul. 31, 2023, titled “System and Method for Monitoring Longitudinal Moving Elements”, incorporated herein by reference in its entirety and for all purposes.

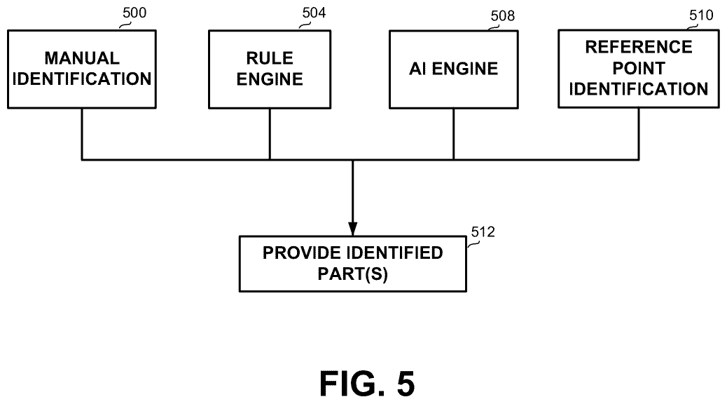

Referring now also to FIG. 5, showing some options for identifying parts within an image, in accordance with some exemplary embodiments of the disclosure.

In some embodiments, identification is performed using manual identification 500, in which one or more areas or segments within an image are presented to a user, and the user identifies the displayed part, for example “a rigid structure”, “a piston”, etc. Optionally, the user approves or disapproves the initial suggestion provided by the system. The user may select the part or complex from a predetermined list, may type in a part name, or the like. If a new part or part type is introduced by a user, the user may connect the part name to a respective engine, to known fault processes, or the like.

In other embodiments, identification can be based upon a rule engine 504, for example “if there is a round structure with an intersecting line it is a top face of a screw”. A rule engine may be implemented as a decision tree, a collection of yes/no questions, or the like.

In further embodiments, identification can be based upon one or more engines 508, which may receive as input an image or a portion thereof, and provide a classification into one (or more) of predetermined classes, wherein each class may be associated with a particular part type. In some embodiments, the classifier may provide a number indicating the degree of association of the image for each class, and generally the image is associated with the class having the highest association degree. As detailed above, a plurality of engines may be used, and the class may be selected using for example majority voting. It is appreciated that a part may be associated with a plurality of labels, for example “a metal object” and “a screw”, thus rendering it to one or more respective failure modes associated with each label.

The engine may be trained upon a plurality of images depicting parts of the desired types, each image labeled with the correct part type depicted therein.

In some embodiments, and in particular when multiple parts of a same complex are captured in an image, on step 510 the parts may be detected and/or identified using reference points associated with each part.

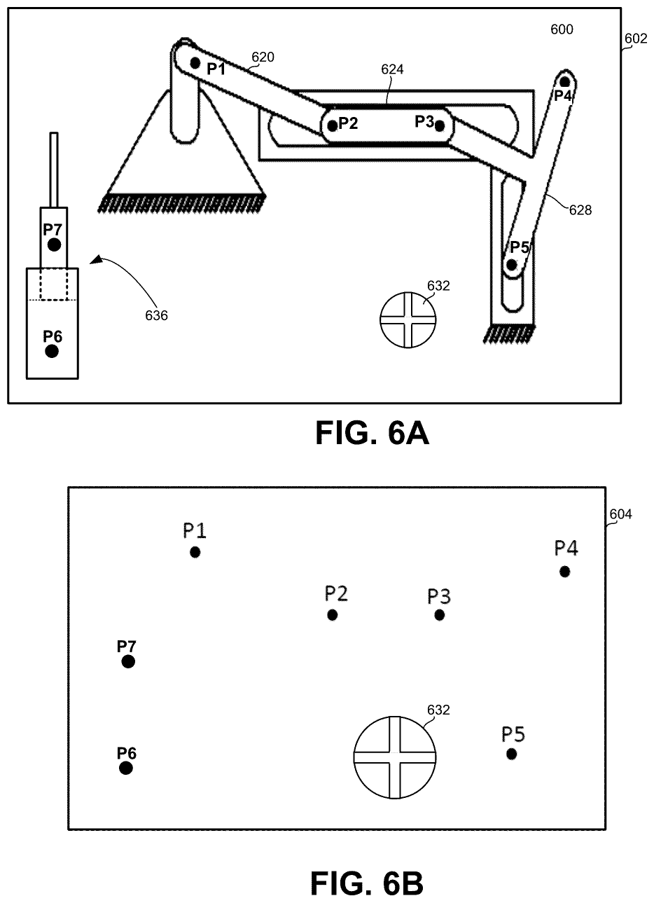

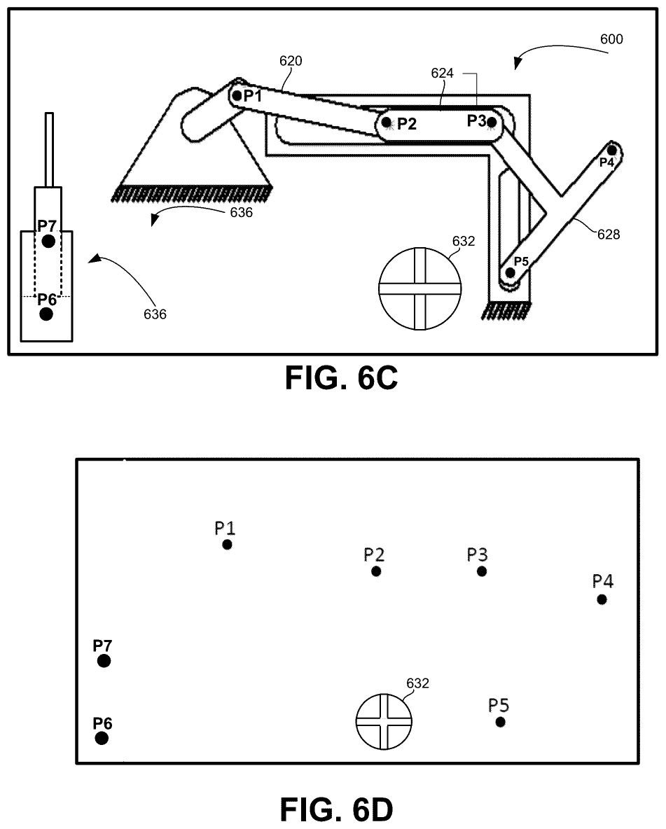

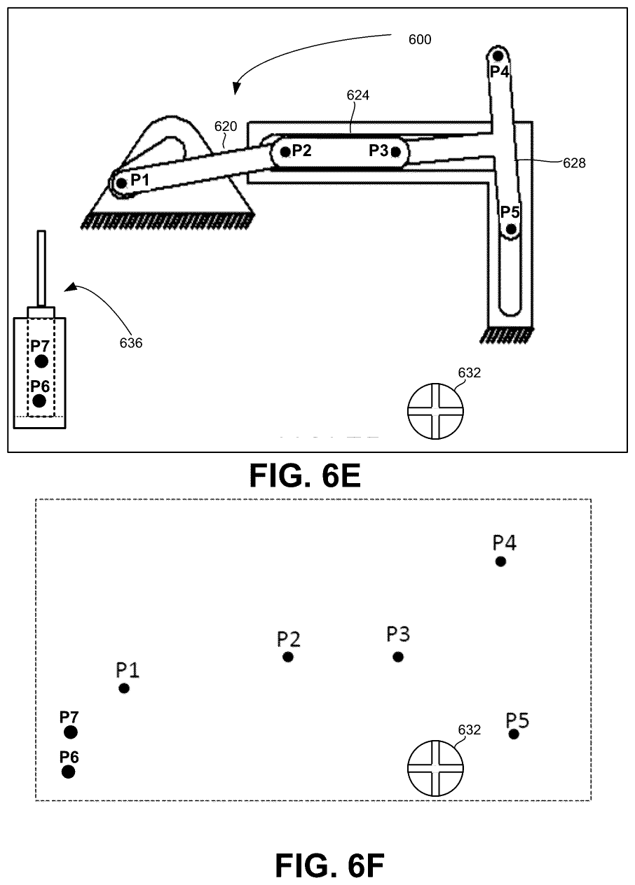

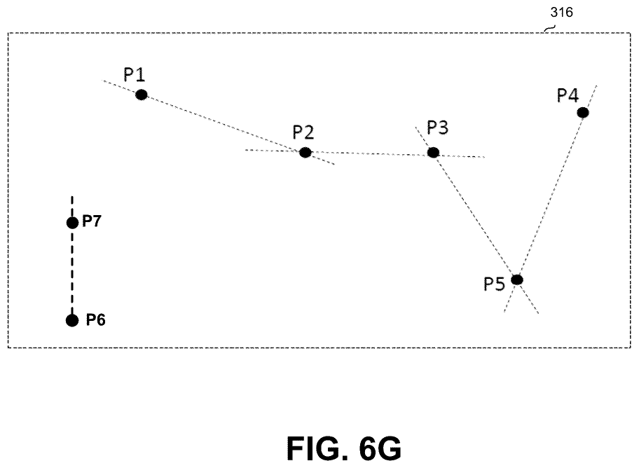

Referring now to FIGS. 6A-6G showing an example of a single frame capturing a complex comprising multiple parts as well as one or more other parts or complexes, and their detection and identification, in accordance with some exemplary embodiments of the disclosure.

FIGS. 6A, 6C and 6E illustrate side views of three exemplary states of complex 600 as well as another part 632 and/or complex 636. In this example five reference points P1-P5 have been defined on complex 600. A point may be defined as a reference point, for example, since it is an end point of a part, it is a joint at which two or more parts connect, it is easy to detect in an image, its movement is easy to describe, or the like. Similarly, two points P6 and P7 have been defined on complex 636, wherein P7 may move and P6 is static.

It is appreciated that a part may be identified by one or more reference points. For example, part 620 may be identified by reference points P1 or P2, while part 624 may be identified by reference points P2 or P3, and part 628 may be identified by reference points P4 or P5. However, it is required that the number of monitored reference points is at least equal to the number of monitored parts.

Moreover, three dimensional information about the parts and their states may be obtained from a plurality of images taken over time by one sensor capturing the plurality of parts. The three dimensional information provides for obtaining information about further points of one or more parts using knowledge about the structure of the parts and/or geometrical considerations. Further, identifying three or more points on a part provides for calculating its translation and rotation in the space and thus its trajectory.

It is appreciated that in order to assess a proper motion of a part, it is required that at least two points in a two dimensional motion and at least three points in a three dimensional motion need to comply with the expected motion, such that the motion of the part as a whole may be assumed to be correct.

FIGS. 6B, 6D and 6F show the alignment of reference points P1-P7 when complex 600 is in the first, second and third states, respectively and complex 636 is also in three different states, whether the states of complex 600 and complex 636 are related to each other or not. As can be seen in FIGS. 6B, 6D and 6F, reference points P1-P5 assume different relative positions in each state. Thus, the relative position of reference points P1-P5 relative to points P6 or P7, or to part 632, may be used to determine what state complex 600 is at, or whether complex 600 is in an undefined state. It is appreciated that complex 600, when operating properly, can be in multiple other states, whether in transit between two of the shown states or others.

FIG. 6G shows the alignment of reference points P1-P5 in state 1 and points P6-P7 at the same time, with the addition of dashed lines showing the angles and distances between the reference points. Further details may be found in PCT/IL2023/050428, published as WO 2023/209717 filed Apr. 25, 2023, titled “Monitoring a mechanism or a component thereof”.

In some embodiments, a combination of two or three of options 500, 504, 508 and 510 may be applied for identifying the parts. For example, a rule engine 504 or an engine 508 may be used, and if unsuccessful a user may assist and provide manual identification 500. It is appreciated that further options or engines may be applied for identifying parts.

On step 512, the identified parts may be provided and the process of FIG. 2B may be continued.

Referring now back to FIG. 2B, once one or more parts are identified on step 212, on step 216 the relevant failure modes may be retrieved for each identified part, as exemplified in FIG. 1.

Step 216 may comprise step 254 for retrieving static failure modes relevant to one or more parts, such as parts 620, 624, 628 and 632. In some embodiments, the failure modes may be retrieved with relevant parameters which may indicate the fault point, the failure point, an acceptable change rate, or the like. In some embodiments, trends of one or more failure modes may also be retrieved, indicating for example an expected change rate between fault and failure, relevant recommendations, or the like. In some embodiments, the failure modes and/or trends are retrieved along with operation and/or environmental parameters. For example, vibrating may be a failure mode, however at certain air pressure vibration is allowed. In some embodiments, failure modes may be allowed between “normal” modes. For example, if an image represents a failure mode but the previous and next image do not represent such failure mode, the failure mode may be ignored or suppressed.

The static failure modes and/or trends may be supplied by a manufacturer of the part or the device, entered by an experienced user, learned by a trained engine, and/or the like. The failure modes may be expressed visually in images, numerically for example in percentage, length, or other units, or in any other manner.

For example, rust may have a fault point when it covers 2% of the surface of the part which is not harmful but needs to be monitored to observe whether it is increasing, and a failure point when it covers 30% of the surface of the part in which the rusted part may break. In another example, deformation may vary between a fault point such as 0.5 mm (it is appreciated that this is only an example, and an acceptable deformation depends on the part, the device, the temperature and conditions in which the device operates, or the like) and 1 cm which is unacceptable and the machine needs an immediate fix. In some embodiments, the failure modes may also take into account additional parameters such as status of operation of machine for example number of hours the machine is usually used on a day/week/etc., environmental conditions, specific user(s), or the like. For example, in a humid environment, rust may be expected to develop faster than in dry conditions, a vibrating part may be subject to faster cracks if installed in an aircraft than in a stationary device, or the like.

Step 216 may comprise step 258 for retrieving dynamic failure modes associated with one or more parts. Dynamic failure modes may refer to a situation wherein one or more parts of a complex of the system are not moving as expected.

Still referring to FIG. 2B, at step 250 possible multi-part failure modes may be retrieved. For example, a single image may capture a landing gear and a screw, a piston, or the like. Analysis of the failure modes may be performed by a different engine for each part or complex and by a further additional engine for the interrelationship between the parts or complexes. In some situations the failure mode of the first part or complex causes the failure mode of the second, while in other situations another cause is responsible for the first failure mode as well as the second failure mode. On further situations, the first failure mode may be caused by a first cause, while the second failure mode may be caused by a second cause. The failure mode of the first part or complex may be static or dynamic, and likewise for the second one.

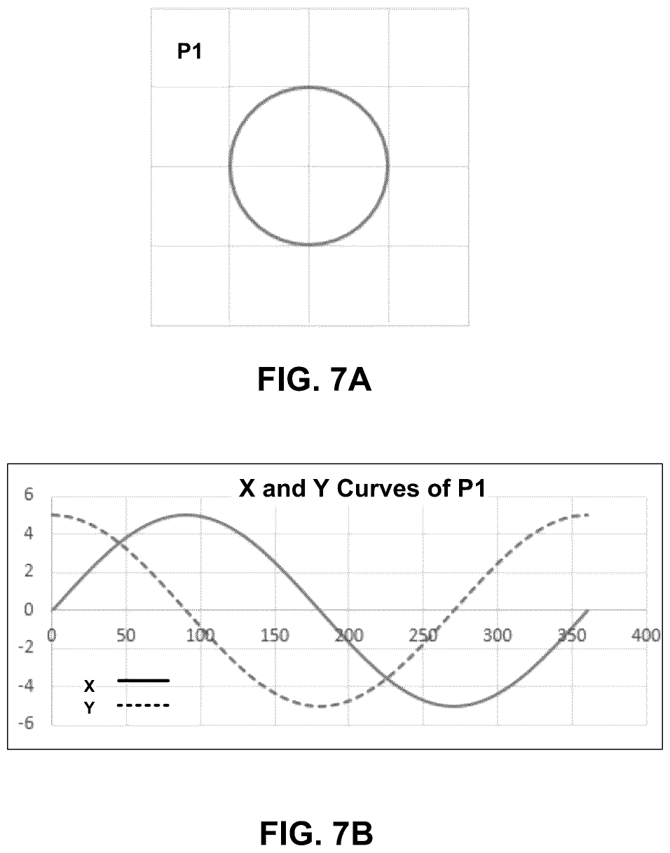

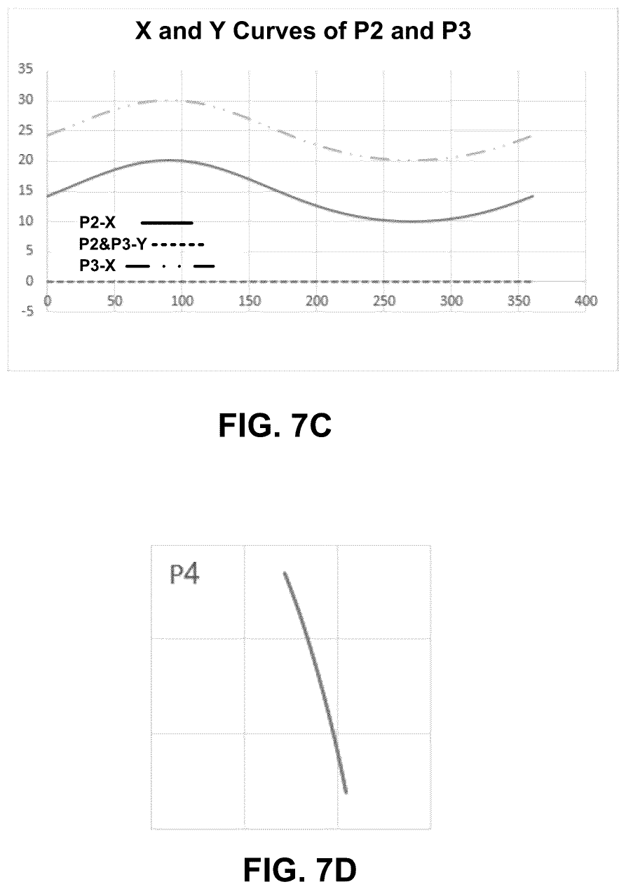

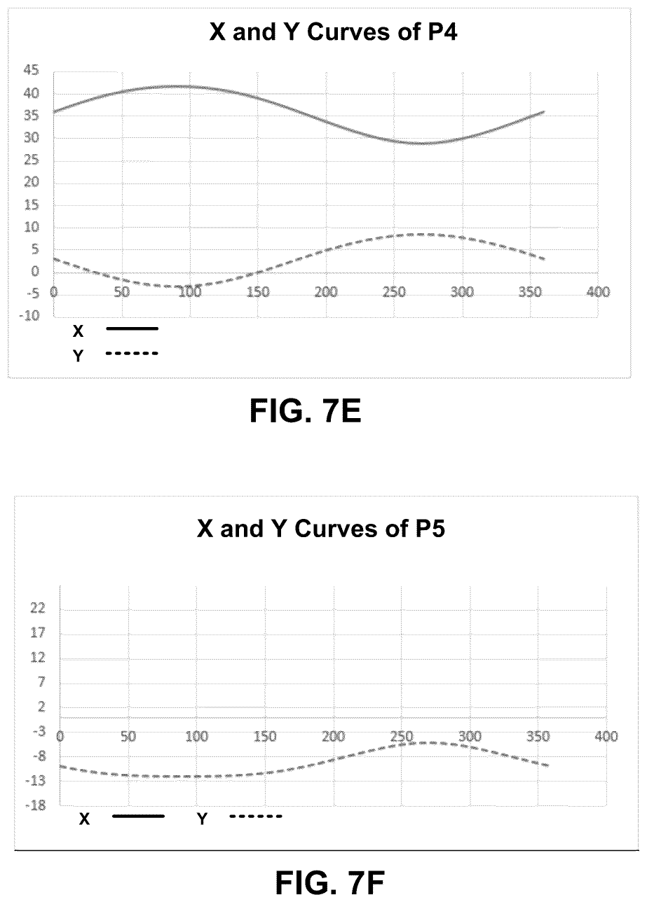

Referring now to FIGS. 7A-7F, showing the motion trajectories of reference points P1-P5 during proper operation of complex 600, upon which dynamic failure modes may be identified, in accordance with some exemplary embodiments of the disclosure.

As can be seen from FIG. 7A, reference point P1 moves along a circular curve. FIG. 7B shows the location of reference point P1 as curves in the X and Y dimensions.

Reference points P2 and P3 move along a linear horizontal trajectory during proper operation, and their curves in the X and Y dimensions are shown in FIG. 7C.

Reference point P4 moves along the curve depicted in FIG. 7D during proper operation, and its curves in X and Y dimensions are presented in FIG. 7E.

Reference point P5 moves along a linear vertical line, and its curves in the X and Y dimensions are presented in FIG. 7F.

The trajectories may be analyzed and stored. In some embodiments, the trajectories may be analyzed and stored with reference to other parts or complexes, such as part 632, complex 636 or any of the points thereon, and in particular point P7 which is stable.

Each of the shown trajectories may be associated with an allowed deviation, such that if a point is within the allowed deviation from the trajectory it is acceptable. The allowed deviation may be the same for all trajectories, or may differ for different points. Moreover, in some examples, the deviation may vary along the trajectory.

The motion of a part or complex may be analyzed relative to other parts or complexes. Thus, a complex as a whole may be translated or rotated to another position, such that although its points are in relative positions to each other as expected, it still demonstrates a failure mode. In other situations, one or more of the points of a complex may be in an unexpected position relative to other points, which may demonstrate a different failure mode, such as an internal problem of the complex.

The proper motion of dynamic parts may be obtained in a variety of ways. In some embodiments, the proper motion may be obtained from analyzing images of the captured parts or complexes when the system is operating properly and the motion of points in a complex is coordinated and correlated, and also at the expected locations relative to other parts or complexes, over a representative period of time, for example at least a predetermined number of cycles.

The reference points may be identified within the captured images, and their locations may be tracked. The locations of each point in corresponding cycle times may be averaged in order to obtain the points connected to the graphs as shown.

In other embodiments, the motion may be described in accordance with the output of a simulator simulating the operation of the complex, whether as data or as images. In further embodiments, the motion may be described analytically, for example as one or more formulas. In yet further embodiments, the motion may be described as a discrete collection of locations for a plurality of points in time, as a statistical model, or the like. In yet further embodiments, the expected movement of one or more parts, or other possible dynamic failure modes may be learned by an AI engine, as provided, for example in PCT/IL2023/050428 filed Apr. 25, 2023, incorporated herein by reference in its entirety and for all purposes.

According to some embodiments the alignments and/or trajectories of reference points on the complex, such as those shown in FIGS. 6G and 7A-7F may be used to monitor the position and relative position of the parts or complexes, wherein optionally, a deviation of a reference point that is greater than a permitted deviation from the defined curves is construed as an indication of a problem in the health of the mechanism and as a failure mode of the part.

The proper motions, or any characteristic thereof, such as a graph, a look up table, a formula, or the like may be stored in association with each part or complex. Additionally or alternatively, one or more characteristics of improper motion may also be described. For example, if an observed or a frequent problem causes a known motion of one or more of the points, a characteristic of the motion may also be stored in association with the part.

Some failure modes related to the relative position of parts within a complex, as obtained by detecting the locations of the reference points may also be identified. It is seen that FIGS. 7B, 7C, 7E and 7F show the X or Y dimensions of points P1-P5 of complex 6000 plotted along the same time line, such that the relative locations of any two reference points may be determined for any point in time. Further, the location of each point relative to a different part, such as part 632 may also lead to the detection of a failure mode of complex 600.

In some situations, a first failure mode of a first part or complex may cause a second failure mode of a second part or complex. For example, an improper motion of complex 600 may cause a leak which may further cause rust in part 632 or increased wear and tear of piston 636. In another example, rust in part 632 prevents proper motion of any of the parts of complex 600. It is appreciated that any of the first and second failure modes may be static or dynamic.

Therefore, characteristics of interrelationship between two or more parts, complexes, or failure modes thereof, whether static or dynamic, may be learned and stored. The interrelationships may be obtained automatically, for example, by analyzing relative locations of parts or complexes, analyzing proper relative movement, analyzing static failure mode in one part and motion of the second part that does not comply with an expected motion, failures such as one part which may drip liquid over another, or the like. Further interrelationships may be entered by a user. The interrelationships may be provided by a user or learned by one or more engines, whether either of the failure modes is static or dynamic.

In some embodiments, stored interrelationship may take a form of an AI engine, trained upon as input a collection of sets of images captured by the image capture device and depicting interrelationship between the first part and the second part, each set of images labeled as proper or improper.

Referring now back to FIG. 2A, once scene analysis step 204 has been completed for a reference image and changes are detected on step 202, the image may be provided to an optional suppressor module, for determining whether the change is indicative of a fault or failure.

Thus, on step 220, filtering engine may be applied to the image. The filtering engine may be a trained engine, a manually trained engine, a rule engine or the like. A filtering engine may detect effects which may indicate no change in the monitored parts but rather in the environment, and may thus not imply a change in a monitored part.

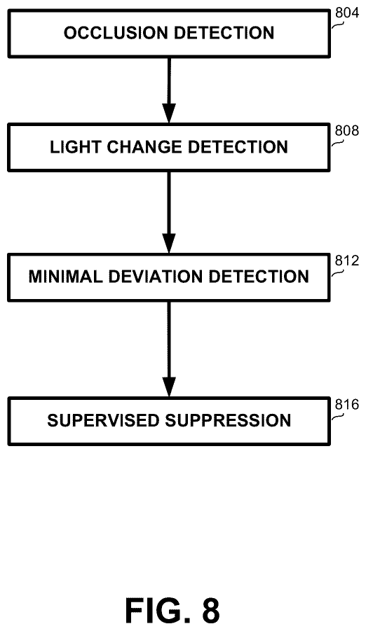

Referring now to FIG. 8, showing a flowchart of optional steps in a method for suppressing situations, in accordance with some exemplary embodiments of the disclosure. It is appreciated that suppressions may occur at different stages of analysis, for example before or after preprocessing, part detection, fault detection or other steps. In some embodiments, different types of suppression or filtering are performed at different stages of the analysis. It is also appreciated that suppression may be affected by other factors such as status of operation of the device, environmental conditions such as temperature, light or dust, usage manner, or the like. Alternatively, no suppression is performed.

On step 804, occlusion detection may be performed, in which it may be detected whether one or more of the parts is fully or partially occluded, such that it looks other than expected, which may happen due to objects coming into and going out of the field of view, camera location and orientation changes, or the like. For example, when reviewing a series of images which are supposed to be without movement of the camera and/or the monitored device, and in one or more images a part seems different, it may be subject to occlusion by another object or part. In some situations, occlusion may be detected by a portion of the part looking as usual, while another portion seems to be part of another object.

On step 808, it may be determined whether the lighting condition have changed, causing a change in how one or more parts appear. This change may also be due to movement of the device and/or the camera, but also due to different light shed on the device, absence or presence of daylight, or the like. Light change may be detected, for example, by identifying pixel values histogram comparison. It is appreciated that if a rule engine, a trained engine, or any other engine is used for identifying such situations, the engine may be trained or designed with attention to such heterogenous conditions.

On step 812, it may be detected whether a moving part is moving not in line with its expected trajectory either due to some parts thereof not moving as expected relative to others, or due to unexpected movement relative to other parts captured in the same image. In case the moving part is at a minimal deviation from an expected trajectory, the deviation may be ignored and the motion may be considered proper.

On step 816 supervised suppression may be performed by a user, wherein an image of the part may be displayed to a user, and the user determines whether the part is fine or is in a failure mode.

Additionally or alternatively, filtering may use input from other sensors in order to accept or reject a fault indication. Such sensors may include but are not limited to sensing vibrations, temperature, sound, or the like. In further embodiments, the additional sensor may be a radar, a Lidar or the like. The additional sensors may be integral to the monitored device, part of the installed system, external to the device, or the like. The sensors may be provide their measurements or indications over a communication bus of the device, using a communication channel such as Bluetooth®, or the like.

It is noted that in some embodiments, one or more of the optional steps shown in FIG. 8 may be omitted, and the steps may be performed at any order.

While the changes discussed above may relate to a failure mode applicable to a single part, they may also involve a multi-part failure mode, wherein two parts captured in a same image, are demonstrating failure modes.

The two or more parts or complexes may be checked for having failure modes using different engines, depending for example on the type of the parts or complexes. For example, a screw may be checked for rust or distortions, while a complex may be checked for improper movement.

In some situations, a first failure mode of a first part affects or causes a second failure mode of a second part, while in other situations the first and the second failure modes are caused by a common cause, or by different causes. Thus, on step 224, it may also be determined whether the change indicates a failure mode that involves interrelationships between parts.

Referring now to FIG. 2C showing a flowchart of steps in a method for detecting failure modes that involve interrelationships between parts, in accordance with some exemplary embodiments of the disclosure.

In some embodiments, the method of FIG. 2C may be invoked if it is detected that at least a first part is having a first failure mode or a second part is detected as having a second failure mode.

On step 262, one or more stored characteristics of stored interrelationship between failure modes of parts or complexes may be retrieved. Some characteristics may indicate proper interrelationships such as coordinated motion, proper behavior of the two parts or complexes, or the like. Other characteristics may indicate improper interrelationships, such as mis-coordinated or mis-synchronized motion, or other problems.

On step 266, current characteristics of interrelationships between the parts may be analyzed within the detected failure modes. For example, the current characteristics may indicate the locations of one or more reference points as tracked over time in two or more images. However, the interrelationship may also relate to a situation in which one or more of the failure modes is static.

On step 270, it may be determined whether the current characteristic complies with the stored characteristics. For example it may be determined whether the tracked relative locations of two or more reference points are the same as the stored locations. In another example, a static characteristic of a first part may be compared to a stored static characteristic, while a dynamic characteristic of another part may be compared to a stored one. For example, it may be determined that a screw has a failure mode of rust, and another part is not moving properly.

On step 274, it may be determined whether an action is to be taken, for example if the stored characteristic implies proper behavior and the current characteristic does not comply with it, or if the stored characteristic implies improper behavior and the current characteristic complies with it, then an action may need to be taken.

It is appreciated that the steps of FIG. 2C are not limited to the first and second dynamic failure modes being dynamic, and can be applied towards any combination of the first failure mode being dynamic or static and the second failure mode being dynamic or static.

On step 224, it may be determined whether the change complies with a change expected due to one of the known failure modes, or whether the change is not in a list of changes that may be ignored. Step 224 may be performed by comparing whether the change is identified as an indicator for any of the failure modes.

On step 226, it may be checked whether the change is to be ignored or does not comply with any of the known failure modes, as verified on step 224, in which case execution may return to step 200 for receiving another image.

If the change is to be ignored or does not comply with any of the known failure modes, as verified on step 226, execution may return to step 200 for receiving another image.

If the change is associated with a failure mode, it needs to be further examined. It is appreciated that the steps detailed below may be performed for each identified part separately, to assess its status and take a corresponding action if required. In some embodiments, the parts may also be assessed in different frequencies, even if captured in a same image. For example, one part may be checked every hour while another one is assessed every week. In some embodiments, interrelations between parts and failure modes may also be analyzed, to assess a complex failure, or cases in which a failure mode in one part causes another failure mode in another part. However, in some embodiments, steps 224 and 226 may be ignored and all identified changes are examined.

It is also appreciated that the method may store and use assessments related to one or more parts in certain points in time in order to compare them to further assessments and analyze the change rate.

One or more recognized parts may thus undergo one or more of the steps of scene analysis 204 as detailed on FIG. 2B above, such as preprocessing 208, part detection 212 or part identification 212. In some embodiments, part detection or part identification may not be necessary if there is no movement relative to the reference image.

Once the parts are detected and identified within the image, on step 228 a fault may be recognized and it may be detected to which degree the fault complies with each failure mode.

On step 228, the image and the possible failure modes may be analyzed for detecting whether one or more of the parts is within any of the failure modes, i.e. represents a fault. For example, in order to check whether a screw is in a rusting failure mode, the percentage of rust may be estimated. In another example, for a piston to verify whether it is in a failure mode, its length, straightness, and movement speed and behavior may be estimated. Step 228 may also be operative in checking whether two or more parts are in a multi-part failure mode, as described above.

In some embodiments, it may be assessed whether the part has changed relative to how it was depicted in a previously captured image, which may later be used for assessing a trend.

Determining the status of each part may comprise analyzing the relevant part of the image depicting the part to identify a quantitative degree within a failure mode, such as percentage of rust, length of crack, rotation in degrees, or the like.

The quantitative data may then be provided to a trained engine to assess whether and where the part is having a failure mode and to assess a trend. In some embodiments, a separate engine may be trained and used for each specific failure mode, which may require activating a corresponding engine for each known failure mode. In some embodiments, a hierarchical scheme may be used, in which an initial model may learn and be applied to determine which secondary model should the activated to address the current area, part and additional parameters such as operational or environmental parameters.

The corresponding secondary model may then be applied to assess the fault and the relevant degree. Thus, a single engine may be trained and provided for all failure modes associated with a specific part or part type. In yet further embodiments, all failure modes of all parts may be handled by a single engine. The engine may be trained upon a training set comprising a plurality of records. Each record may comprise one or more points along a fault process, optionally environmental or operation parameters for the device, and one or more labels indicating an expected fault time, a usage recommendation, or the like.

In another example, the status may be determined by a rule engine. For example, the rule engine may also receive such states and time difference, calculate the fault rate, and predict accordingly the expected time for the failure point. In further examples, a human user may receive the states and provide an expected time or date for the failure point.

Referring now back to FIG. 2A, on step 232 it may be determined whether the part is indeed in a failure mode. In some embodiments, the situation includes a combination of an imaged part and inputs from other sensors, environmental data from other sources and/or operation data of the device which may have an impact of the classified situation.

For example, in some situations it may be determined that although there is a fault in the part, it is not expected to develop into a failure, for example the change is minimal, the fault point is expected to occur later than the life expectancy of the device, the environmental conditions will prevent the problem from developing, improved behavior such as more careful driving can eliminate the problem, or the like. In further embodiments, multiple alert levels, such as low, medium and severe may be defined, and the failure mode may be identified to indicate one of them. For example, if the percentage of a part that has rust is below a first threshold, it may be identified as a low alert level, a percentage that is between the first and a second threshold may be identified as a medium alert level, and so on. In some embodiments, the alert levels may be associated with colors to be displayed to a user, such as green, yellow and red for low, medium and high alert levels.

In some cases, such determination may be indicative of a false alarm in identifying the situation, and may thus be used on step 236 to update a training set or otherwise affect a failure mode identification engine or a filtering engine. Once any of the engines is trained with the updated training set, such situations may be better classified. Execution may them return to step 200 for receiving a further image.

If it is determined on step 232 that the part is indeed in a failure mode which may lead to a failure, then on step 240 a trend may be predicted. Prediction may use prior images or data and analysis results thereof, in order to assess a trend. The trend may be predicted based on rate of change in one or more measurements, may take into account environmental conditions, such as mode of operation, pressure, temperature, time of operation, humidity, or the like. The trend may also use data from external sensors as detailed in association with the suppression above. In some embodiments, the trend may also use specific parameters to the present situation, such as information on a driving behavior of a current driver of a monitored vehicle or planned route of a vehicle. The specific parameters may be received from a user or collected from previous analysis performed on the device. In some embodiments, it may be attempted to affect the trend, for example by disabling the device from operating in high strain, such as high speed, in order to reduce the failure mode development rate.

For example, if rust percentage has been 2% a week ago and is 10% now, it may be predicted that in two weeks it will reach 30% which is the failure point. In addition, it may be predicted that the rust percentage increased due to specific environmental conditions which are not expected in the near future and therefore the increase in rust is expected to be slower. The prediction may use any tools available for trend analysis, including engines, statistical and mathematical tools, historical histograms, manual inputs and/or the like.

Additionally, trend prediction may also identify correlation between different parts of the monitored device, for example corrosion in one part can cause a defect in another part, dripping of liquid from one part may make another part seem different although there is no problem with the other part, or the like.

In some embodiments, the trend calculation may also take into account known usage of the monitored device. For example, if a cable can hold for 10 more flights and the aircraft only flies 5 times a month, it may be determined that a cable needs to be replaced within two months. Optionally, the usage may be based on behavior of a specific user of the machine, for example a specific driver is known to use breaks more than others at which it is calculated that breaks have to be replaced earlier.

It is appreciated that trend detections step 240 may also use an engine trained upon a collection of records, each record comprises a state of a part, and optionally usage information, environmental conditions, or data related to other parts and one or more labels indicating an expected failure date or another information.

On step 244, an action may be taken, such as but not limited to any one or more of the following: sending a message to a person in charge; displaying a notice to a user over a display device; providing a recommendation such as for replacing a part, tightening screw, cleaning, or the like; updating a technician schedule; ordering parts; changing a capture rate for the camera; changing an analysis rate for further images captured by the camera or parts thereof; changing analysis process of further images; storing an alert in a storage device; updating a database, or the like.

In some embodiments a different analysis rate may be set for different parts of a device displayed in a single image. For example, if a camera is capturing a rigid structure and a connector, the part of the image depicting the rigid structure may be analyzed every day, while the part of the image depicting the connector may be analyzed every hour. In these embodiments, at times, some of the images are analyzed only for one part of the machine. In some embodiments, the entire image is analyzed each time but only for failure mode associated with the respective part to be analyzed at the specific time.

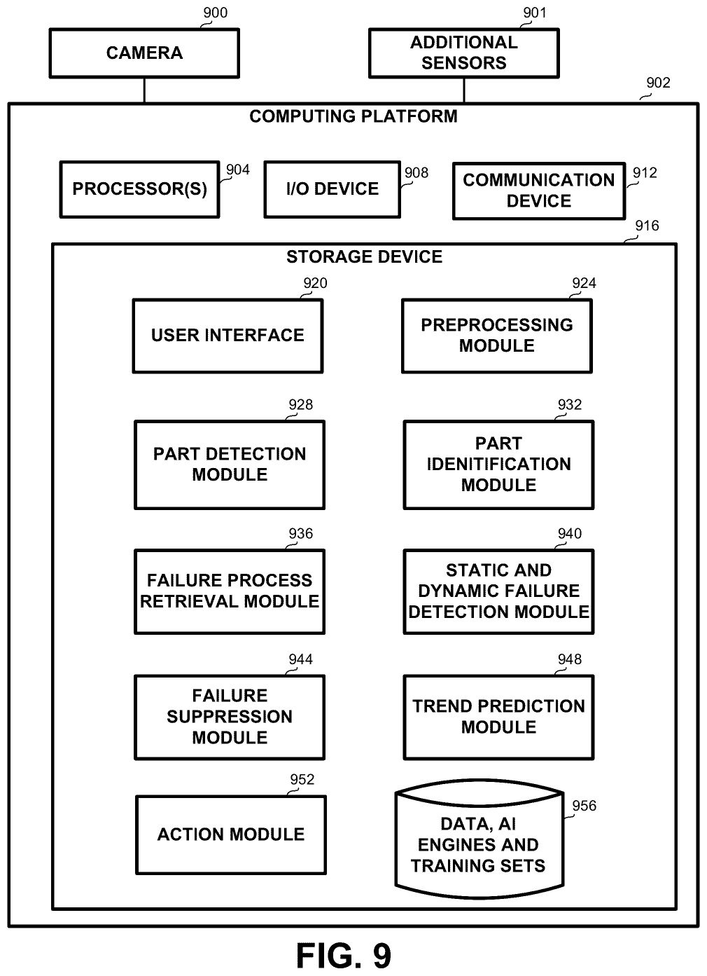

Referring now to FIG. 9, showing a block diagram of a system for predictive maintenance of a monitored device, in accordance with some exemplary embodiments of the disclosure.

The system may comprise one or more cameras 900. The camera may be small enough to fit into unreachable or hard to reach locations within or in the vicinity of the monitored device. The camera may be in communication with one or more computing platform(s) 702. The communication may be wired or wireless and may be use any required protocol, such as Bluetooth®, Wi-fi, cellular, Wide Area Network, a Local Area Network, intranet, Internet, or the like. In some embodiments, portions of the computing platform may be installed with the camera and other parts are provided remote thereof.

The system may comprise one or more additional sensors 901, such as temperature, humidity, vibration, pressure or the like. The sensors may provide output which as detailed above may affect decisions such as whether a part in fault, the trend of the part, an action to be taken, or the like. The sensors may be in communication computing platform(s) 902. The communication may be wired or wireless and may be use any required protocol, such as Bluetooth®, Wi-fi, cellular, Wide Area Network, a Local Area Network, intranet, Internet, or the like.

In some embodiments, computing platform 902 may be located anywhere and accessed through a communication channel by one or more cameras. In some embodiments, computing platform 702 may provide services over a network to one or more cameras.

It will be appreciated that computing platform 902 may be implemented as one or more computing platforms collocated or not, which may be in operative communication with one another. Thus, one or more of computing platform 902 may be located in a housing comprising camera 700, elsewhere within or near the monitored device, on premises with the monitored device, at a remote location, for example within a cloud computing device.

Computing platform 902 may comprise a processor or processor circuitry 704 which may be one or more Central Processing Unit (CPU), a microprocessor, an electronic circuit, an Integrated Circuit (IC) or the like. Processor 704 may be configured to provide the required functionality, for example by loading to memory and activating the modules stored on storage device 916 detailed below. It will also be appreciated that processor 904 may be implemented as one or more processors or processing circuitries, whether located on the same platform or not.

Computing platform 902 may also comprise Input/Output (I/O) device 908 such as a display, a pointing device, a keyboard, a touch screen, or the like. I/O device 908 may be utilized to receive input from and provide output to a user, for example enter monitored device data, enter fault and failure points, provide training examples, receive notifications and reports related to a monitored device, or the like.

Computing platform 902 may comprise communication device 912 for communicating with camera 900 and/or other devices such as other computing platforms, for example a server or other computing platforms within a cloud, via any communication channel, such as a cellular network, Wide Area Network, a Local Area Network, intranet, Internet or the like. Other computing platforms may comprise and transmit, for example, engines trained upon data form multiple devices,

Computing platform 902 may also comprise a storage device 916, such as a hard disk drive, a Flash disk, a Random Access Memory (RAM), a memory chip, or the like. Storage device 716 may also be distributed among two or more platforms, stored locally, on premise, on a cloud storage device, or the like.

In some exemplary embodiments, storage device 916 may retain program code operative to cause processor 904 to perform acts associated with any of the modules listed below or steps of the methods of FIGS. 2A, 2B, 2C, 5, and 8 above. The program code may comprise one or more executable units, such as modules, functions, libraries, standalone programs or the like, adapted to execute instructions as detailed below.

Storage device 916 may retain user interface 920 for receiving data and displaying queries, notifications, alerts, reports or results to a user. User interface 920 may also display to the user various stages in the process for the user to enter data, confirm displayed data, accept or reject failures, or the like. In some embodiments, at least some of the images analyzed in which a fault is detected is displayed to the user by user-interface 920.

User interface 920 may be displayed over visual I/O device 908, played over a speaker, printed, or the like.

Storage device 916 may retain preprocessing module 924, for performing preprocessing operations on an image, such as color correction 300, augmentation 304, registration with additional image(s) 308, filtering 312, tiling 316 or batching 320. It is appreciated that preprocessing module 924 may comprise separate modules for the various operations, or a single module.

Storage device 916 may retain part detection module 928 for detecting the location of one or more parts in an image, possibly after the image has been preprocessed. Part detection module 928 may perform semantic segmentation 404, feature extraction 408, edge detection 412 or area detection 416. It is appreciated that part detection module 928 may comprise separate modules for the various operations, or a single module.

Storage device 916 may retain part identification module 932 for identifying the parts detected by part detection module 928. Knowing the part enables the retrieval of specific information related to possible failures thereof. Identification of a part may be performed, for example, using manual identification 500, rule engine 504 or engine 508.

In some embodiments, part identification module 932 may be implemented with, or as part of part detection module 928.

Storage device 916 may retain failure modes retrieval module 936 for retrieving the known failure modes for a part. One or more failure modes may be associated with and retrieved with a fault point, a failure point and data about the progress from one to the other, such as acceptable rate.

Storage device 916 may retain failure detection module 940 for determining whether the specific part is subject to one or more of the specific failure modes associated with it, and to what degree. Failure detection module 940 may be operative in detecting both static and dynamic failure modes, for example by examining a single image for a state of a part, or by analyzing a set of images for analyzing the motion of one or more parts, or relative motion between parts.

Storage device 916 may retain failure suppression module 944 for eliminating one or more identified failures, due for example to detected occlusion, detected light change, user instructions, or the like. Failure suppression module 944 may also be configured to determine that although the specific part is at fault, this is normal and does not require special attention.

Storage device 916 may retain trend prediction module 948 for determining a trend of the failure mode. Predicting the trend may use comparison between images of the part captured over a period of time, historical data, statistical data of the usage of the part or the monitored device, or the like.

Storage device 916 may retain action module 952 for taking an action, such as sending a notification to one or more recipients, issuing a report, stopping a machine, scheduling a technician visit, changing a capture rate of camera 900, changing analysis rate of images captured by camera 900 or parts thereof, or the like.

Storage device 916 may retain database 956 adapted to store data collected over a period of time, such as images, mage analysis results, discovered failure modes, trends, or the like. Database 956 may also store one or more trained engines, images and data to be used as training sets, or the like. It is appreciated that training any of the engine may be performed by any of computing platforms 902, or another computing platform. It is also appreciated that database 956 may be implemented as one or more databases, which may be stored within the system, on the device, on-premise at a location neat the device, on a remote storage device such as cloud storage, or the like.

The present disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor or processor circuitry of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the invention in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A system, comprising:
at least one processor programmed to:
receive an image captured by a camera, the image depicting
at least two parts of a monitored device, a first part of the at least two parts subject to at least one first failure mode, and a second part of the at least two parts subject to at least one second failure mode;
identify in the image the first part and the second part;
detect whether the first part is assumed to comply with the at least one first failure mode, comprising using at least a first engine, and whether the second part is assumed to comply with the at least one second failure mode, comprising using at least a second engine;
verify whether the first part complies with the at least one first failure mode or not, and verify whether the second part complies with the at least one second failure mode or not; and
take at least one action subject to the first part complying with the at least one first failure mode or the second part complying with the at least one second failure mode, the at least one action aimed at avoiding a malfunction of the device.

2. The system according to claim 1, wherein verifying whether the first part complies with the at least one first failure mode or not, and verifying whether the second part complies with the at least one second failure mode or not comprises:
retrieving from a storage device a stored characteristic of stored interrelationship between the first part and the second part;
analyzing within the image a current characteristic of current interrelationship between the first part or the second part;
determining whether the current characteristic complies with the stored characteristic;
subject to the stored interrelationship representing proper multi-part interrelationship, and the current characteristic not complying with the stored characteristic, or to the stored interrelationship representing improper interrelationship between the first part and the second part and the current characteristic complying with the stored characteristic, determining to take the at least one action.

3. The system according to claim 1, wherein the at least one first failure mode and the at least one second failure mode are static failure modes.

4. The system according to claim 3, wherein a static failure mode of the at least one first part causes the at least one second failure mode.

5. The system according to claim 1, wherein the at least one first failure mode is a static failure mode and the at least one second failure mode is a dynamic failure mode.

6. The system according to claim 5, wherein the processor is adapted to analyze a static failure mode in the at least one first part, and motion of the at least one second part that does not comply with an expected motion.

7. The system according to claim 1, wherein the at least one first failure mode and the at least one second failure mode are dynamic failure modes.

8. The system according to claim 7, wherein the processor is adapted to analyze motion of the at least one first part that does not comply with an expected motion for the first part, and to analyze motion of the at least one second part that does not comply with an expected motion of the second part.

9. The system according to claim 8, wherein the stored interrelationship of the first part and the second part indicate synchronization in time or space between motions of the first part and the second part, and wherein detecting whether the second part is assumed to comply with the at least one second failure mode comprises detecting whether a second motion of the at least one second part is incompatible in time or space with a first motion of the at least one first part.

10. The system according to claim 2, wherein the processor is further adapted to train an engine by providing as input a collection of sets of images captured by the image capture device depicting interrelationship between the at least one first part and the at least one second part, each set of images labeled as proper or improper, and wherein the engine is adapted to receive a set of images and predict whether the first part and the second part move in expected trajectories and in synchronization.

11. The system according to claim 2 wherein the stored interrelationship have been obtained by an engine receiving as input for training a collection of sets of images generated by a simulator depicting interrelationship between the first part and the second part, each set of images labeled as proper and improper.

12. The system according to claim 1 further comprising: a camera configured to capture the image of the monitored device.

13. The system according to claim 1, wherein the at least one action comprises alerting a user.

14. The system according to claim 1, wherein the at least one action comprises scheduling a maintenance operation.

15. The system according to claim 1, wherein the at least one action comprises analyzing a trend of the failure mode.

16. The system according to claim 1, wherein the at least one action comprises suggesting a change to the operation mode of the monitored device or a part thereof.

17. The system according to claim 1, wherein the at least one action comprises at least one item selected from the group consisting of: changing a capture rate for the camera; setting an analysis rate for at least a portion of further images captured by the camera; sending a message to a person in charge; storing an alert in a storage device; and updating a database.

18. The system according to claim 1, wherein the image is divided into tiles, and wherein at least one tile is analyzed at a different frequency from at least one other tile.

19. A method for monitoring a device, comprising:
receiving an image captured by a camera, the image depicting at least two parts of a monitored device, a first part of the at least two parts subject to at least one first failure mode, and a second part of the at least two parts subject to at least one second failure mode;
identifying in the image the first part and the second part;
detecting whether the first part is assumed to comply with the at least one first failure mode, comprising using at least a first engine, and whether the second part is assumed to comply with the at least one second failure mode, comprising using at least a second engine;
verifying whether the first part complies with the at least one first failure mode or not, and verifying whether the second part complies with the at least one second failure mode or not; and
taking at least one action subject to the first part complying with the at least one first failure mode or the second part complying with the at least one second failure mode, the at least one action aimed at avoiding a malfunction of the device.

20. The method according to claim 19, wherein verifying whether the first part complies with the at least one first failure mode or not, and verifying whether the second part complies with the at least one second failure mode or not comprises:
retrieving from a storage device a stored characteristic of stored interrelationship between the first part and the second part;
analyzing within the image a current characteristic of current interrelationship between the first part or the second part;
determining whether the current characteristic complies with the stored characteristic;
subject to the stored interrelationship representing proper multi-part interrelationship, and the current characteristic not complying with the stored characteristic, or to the stored interrelationship representing improper interrelationship between the first part and the second part and the current characteristic complying with the stored characteristic, determining to take the at least one action.

21. A computer program product comprising a non-transitory computer readable medium retaining program instructions, which instructions when read by a processor, cause the processor to perform:
receiving an image captured by a camera, the image depicting at least two parts of a monitored device, a first part of the at least two parts subject to at least one first failure mode, and a second part of the at least two parts subject to at least one second failure mode;
identifying in the image the first part and the second part;
detecting whether the first part is assumed to comply with the at least one first failure mode, comprising using at least a first engine, and whether the second part is assumed to comply with the at least one second failure mode, comprising using at least a second engine;
verifying whether the first part complies with the at least one first failure mode or not, and verify whether the second part complies with the at least one second failure mode or not; and
taking at least one action subject to the first part complying with the at least one first failure mode or the second part complying with the at least one second failure mode, the at least one action aimed at avoiding a malfunction of the device.
